(19) United States
(12) Patent Application Publication
(10) Pub. No.: US 2002/0082897 A1
(43) Pub. Date: Jun. 27, 2002

(54) Method and apparatus for facilitating amusement park activities and storing demographic information

(76) Inventors: Douglas Menelly, Bellmore, NY (US); Ching Yi, Jackson Heights, NY (US); Keith Donaldson, Wantagh, NY (US)

Correspondence Address: RICHARD MENELLY, 18 Saco Road, Alfred, ME, 04002, US

(21) Appl. No.: 09/746,911

(22) Filed: Dec. 26, 2000

(51) Int. Cl. G06F 17/60

(52) U.S. Cl. 705/10

(57) ABSTRACT

An interactive information system includes personal bracelets containing passive electronic devices interacting with a plurality of receiver units, a central database, and a processor unit located within an amusement park. People wear the bracelets with self-contained receivers that contain unique identification codes to electronically link receiver units within a selected group. Scanners strategically located at attractions and in kiosks throughout the park relay positional data sent to a main database and computer for processing thereby enable users access to positional information of group members, reserve time slots on rides and attractions along with the ability to order and pay for food and other services.

### 1. BACKGROUND OF THE INVENTION

The present invention relates to contactless tracking systems and, more particularly, is directed to interactive amusement parks and data collection.

Customers attend amusement parks to have a fun and enjoyable experience. However, amusement parks usually characterize crowds of people, long waiting lines, numerous facilities and a plethora of information relating to park activities.

Accordingly, there exists a demand for an interactive communications system for optimizing a customer's time in an amusement park. There also exists a need by the park management for reliable data collection of park activities for monitoring and determining the popularity of attractions.

One current attempt to enhance a park visitor's experience is described by Parkwatch Inc:

for tracking groups of individuals in amusement parks. The Parkwatch system incorporates waterproof transmission devices that can be worn like a wristwatch or can be clipped onto clothing. At the time of rental, the transmitters are linked in the park's computer network and associated with each individual's name. Each device transmits a unique signal at specified time intervals, such as every eight seconds, for example. Antennas throughout the park pick up the signals and relay them to a central computer. The central computer matches the signals with each individual's location through triangulation. Kiosks equipped with scanners and map displays are also located throughout the park. When an individual within the group scans his/her transmission device at one of the kiosks, the central computer identifies the individual and displays the location of the individuals associated with the group onto a map display.

U.S. Pat. No. 5,987,421 describes a wireless arrangement that reduces wait time in amusement parks by allowing a group of park visitors to find the location other visitors within the group at any given time. This information can be drawn from a hand-held computer screen by scrolling through the list of people in the group, selecting the one person, and then transmitting a wireless message to the targeted person's handheld system. The targeted person's handheld system responds by emitting an audible sound to alert the targeted person that someone within the group is looking for them.

A communication system designed for use within amusement parks and the like is the FASTPASS product, which is a registered trademark belonging to Disney Inc., which allows a user to slide a park ticket through associated turnstiles for allowing the user direct access to a ride without waiting in line.

One such communication system designed for use on golf courses to provide accurate information to the golfers and course managers is the GPS system belonging to Parview Industries. The GPS system provides golfers with graphical hole and green overviews, exact distancing, pro tips, electronic scoring, live tournament leader board, weather and safety messaging, two-way communication, and food and beverage ordering.

The cost and inconveniences associated with the aforementioned user associated devices along with the limited use and control by the individual user had prevented widespread usage within the amusement industries.

The purpose of the present invention is to allow one person within a group of attendees at an amusement facility to immediately determine the location any other member of the group as well as reducing the wait times associated with the amusement rides, relaxation facilities, restaurants and the like.

### SUMMARY OF THE INVENTION

An interactive information system for amusement parks and the like includes personal bracelets containing passive electronic devices associated with receiver units, a central database, and a processor unit within the amusement park Scanners strategically located throughout the park relay positional data sent to a main database and computer for processing.

### BRIEF DESCRIPTION OF THE DRAWINGS

FIG. 1 is a diagrammatic representation of the Facilitating Amusement Park Activities and Storing Demographic Information Arrangement according to the invention;

FIG. 2 is a partial top perspective view of the transponder bracelet used with the Arrangement of FIG. 1;

FIG. 3 is a block diagram description of the electrical components within the Arrangement of FIG. 1;

FIG. 4 is a flow chart representation of the operational algorithms embodied within the Data Input Module of FIG. 3;

FIG. 5 is a flow chart representation of the operational algorithms embodied within the Query Authorization Module of FIG. 3;

FIG. 6 is a flow chart representation of the operational algorithms embodied within the Data Base Module of FIG. 3;

FIG. 7 is a flow chart representation of the operational algorithms embodied within the Full Access Query Module of FIG. 3; and

FIG. 8 is a flow chart representation of the operational algorithms embodied within the Output Module of FIG. 3.

### DESCRIPTION OF THE PREFERRED EMBODIMENT

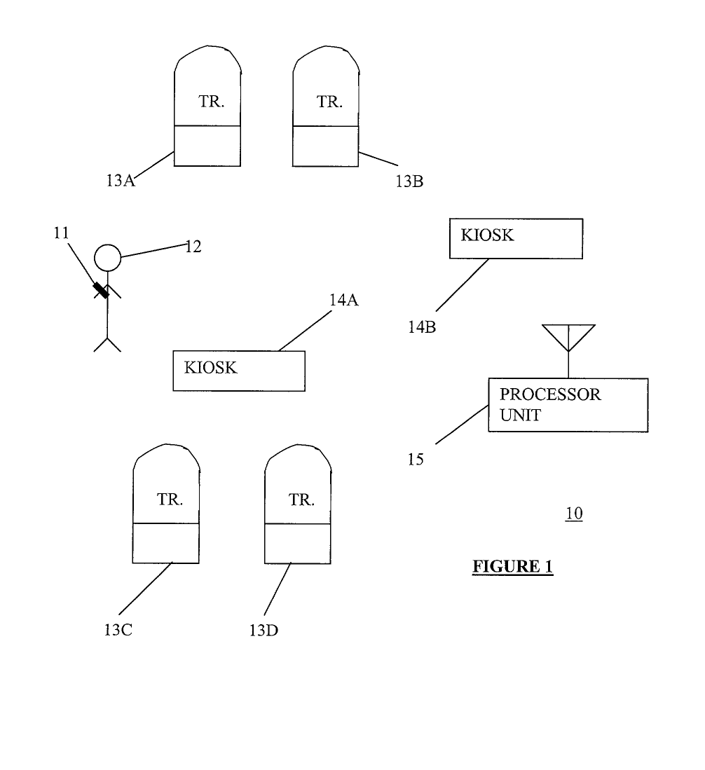

The interactive system for facilitating amusement park activities and storing demographic information invention, hereinafter “interactive system” 10, enhances the experience of large-sized amusement parks such as that indicated in phantom at 9 in FIG. 1 The first components of the interactive system include transponder bracelets 11 on the wrists of park attendees 12 which contain a unique ID specific to each attendee, and can be linked to other attendees within a group thereof. One example of an efficient transponder is an RI-TRP-VETA obtained from Texas Instruments.

The second components of the system comprise readers 13A-13D such as the Texas Instruments model RI-RFM-HRUA series 5000 UHF located at the entrance to all attractions, restaurants, and games (not shown) throughout the park. These readers serve to track the activity of each attendee by scanning the unique ID in the device within the bracelets 11 This data is sent to the processor unit 15 and is acted upon in the manner to be discussed below. Upon entering the park the attendee is able to select the specific information (e.g. age, sex, zip code, etc.), which is to be linked to the unique ID of each specific bracelet.

The third component of the interactive system includes interactive touch-screen kiosks 14A, 14B located throughout the park, with scanners to read the unique ID on the transponder bracelet. By reading the unique ID on a bracelet, the scanners can track the activity of an attendee and what path the attendee takes throughout the park. Once the unique ID is obtained and recognized at a kiosk, the functionality of the kiosk becomes available to the attendee. For example, the attendee can determine the wait-time for a particular attraction in real-time and reserve a time slot to attend the attraction. Another feature of the kiosk will include food-ordering capabilities whereby the attendee can choose a restaurant located in the park on a touch-screen, and order food directly at the kiosk, requesting that the food be ready for pickup at a certain time. The attendee can then go to the restaurant at the designated time and pickup up the food ordered at the kiosk. Once at the restaurant, the cashier will have a scanner to read the attendee's unique ID within the bracelet to authenticate payment by the attendee. Another feature of the kiosks includes a method to locate other attendees of a particular party. The attendee at the kiosk can choose a specific attendee to locate from a list of the attendees within his party on the kiosk screen, and view a map of the park with the location of the specific attendee. The kiosk includes a method to view the activity of the credit card to the unique ID within the bracelet was selected at the park entrance. One such kiosk that includes a touch-screen monitor, CPU, credit card reader, receipt printer and speaker within an outdoor enclosure unit is an Alliance 1200 obtained from Factura kiosk products.

The fourth component of the system comprises the processor unit 15 described earlier with reference to the bracelets 11. The central database within the processor stores visitor information, park information, daily activity and archived activity. The park information section includes information regarding rides, mini parks, shops, restaurants, and all other attractions. The daily activity section of the database stores all the collected activity data from each individual bracelet.

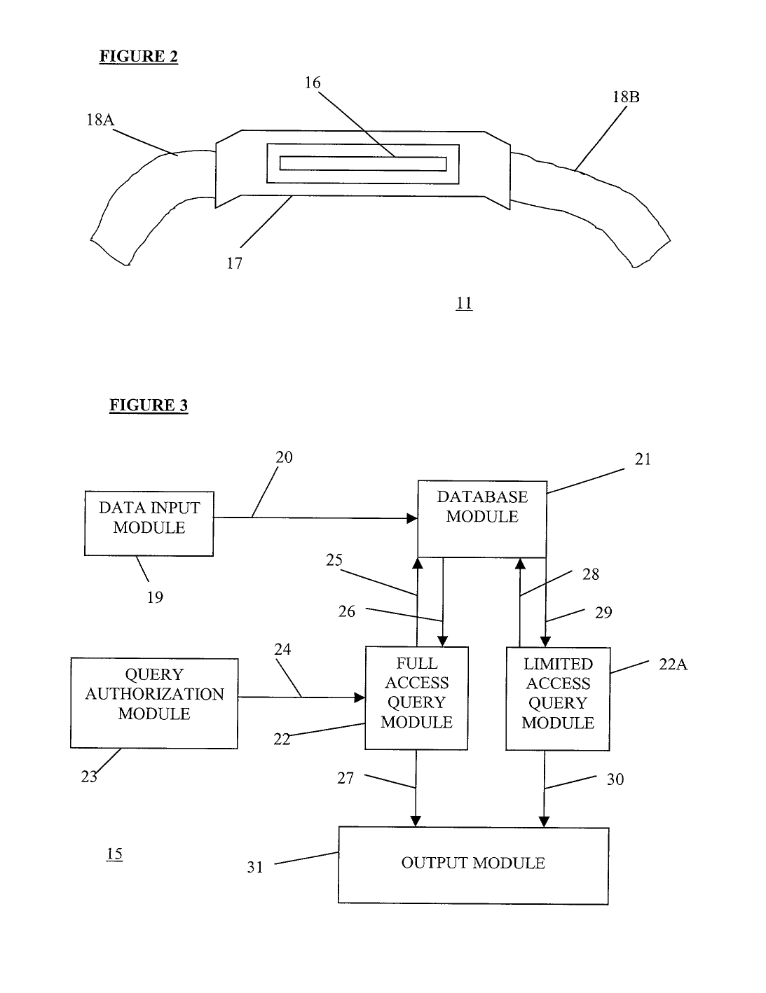

The bracelet 11, shown in FIG. 2, defines a pair of straps 18A, 18B attached to a support plate 17 that houses the transponder 16 which transmits data to the processor 15 which includes the components best seen by referring now to FIG. 3.

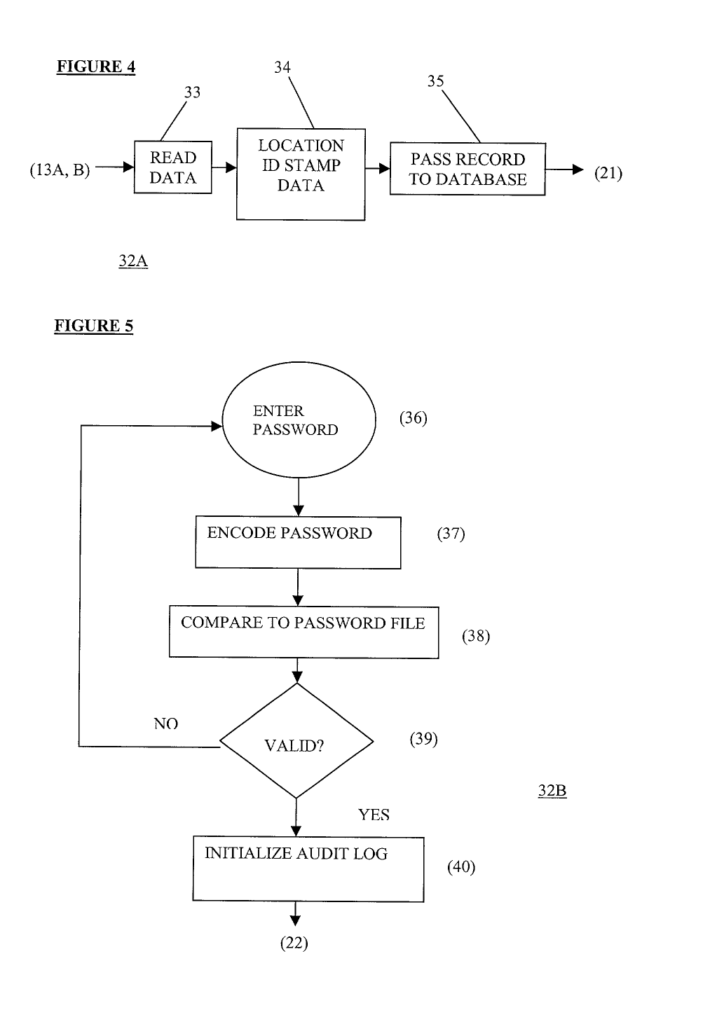

A data input module 19 within the processor 15 connects with the database module 21 via input data bus 20 as now shown in FIG. 4 for providing the input data described earlier. The database module interconnects with a full access query module 22 via data busses 25, 26 and with a limited access query module 22A via data busses 28, 29. A query authorization module 23 connects with the full access query module 22 over data bus 24 for providing verification of the input data. The full access query module 22 and limited access query module 22A interconnect with the output module 31 via data bus 27, 30 respectively. The algorithms for providing the functionality described earlier are depicted in the following FIGS. 4-8.

The operational flow chart 32A for the algorithms embodied within the data input module 19 of FIG. 3 is depicted in FIG. 4 and operates as follows. The attendee 12 (FIG. 1) enters data defining an ID value at one of the transceiver units 13A, 13B which data is transmitted to the data input module 19 and read (33), provided with a location ID stamp (34) and is passed (35) onto the database module 21 of FIG. 3.

The operational flow chart 32B for the algorithms embodied within the query authorization module 23 of FIG. 3 is depicted in FIG. 5 and operates as follows. The attendee enters a password (36) in the query authorization module and the password is encoded (37) and compared to a stored password file (38). If the entered password corresponds to a stored value (39) the audit log within the module is initialized (40) and the data is passed onto the full access query module 22 for further processing. If the proffered password does not correspond to a stored value the password the entry process is repeated (36). To prevent unauthorized password entry, the password entry process is halted after a predetermined number of failed comparisons.

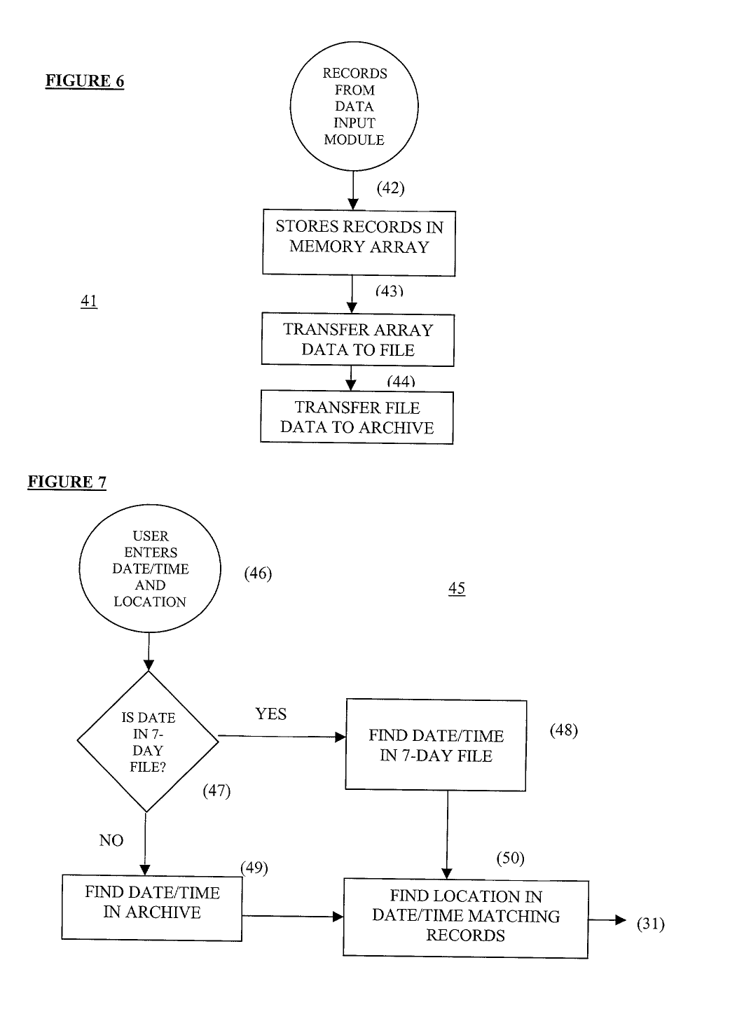

The operational flow chart 41 for the algorithms embodied within the database module 21 of FIG. 3 is depicted in FIG. 6 and operates as follows. The records from the data input module 19 are time-stamped and stored in a memory array before transferring to a file (43) thereafter the file data is transferred to an archive (44). In this manner the received records are stored in chronological order with date-time field combinations serving as an index of the data. At a predetermined interval, such as every five minutes, the records in the array are transferred to the first file representing the most recent accumulated data. If the files are transferred every five minutes, for example, a file capable of storing the last seven days will include 20,160 records for one subject. At a longer predetermined time, such a once a day, the earliest data is transferred to an archive file.

The operational flow chart 45 for the algorithms embodied within the full access query module 22 and limited access query module 22A of FIG. 3 is depicted in FIG. 7 and operates as follows. User input for data base inquiries received from the query authorization module 23 is entered (46) within the full access query module 22 and, depending upon the date specified, a decision is made (47) whether to find the time/date in a seven day file (48) or in an archive (49). If the decision is made to find the time/date in the seven-day file or the archive, the location of the time/date is searched in the matching records file (50) and the matching records are sent to the output module 31 of FIG. 3. The limited access query module 22 differs from the full access query module 22A in two ways. Firstly, there is no password necessary the limited access query module and secondly, the queries therein are appropriately limited. The attendee's activities for only a pre-specified time period can be accessed within the limited access query module whereas all the attendee's activities stored in the full access query module are accessible.

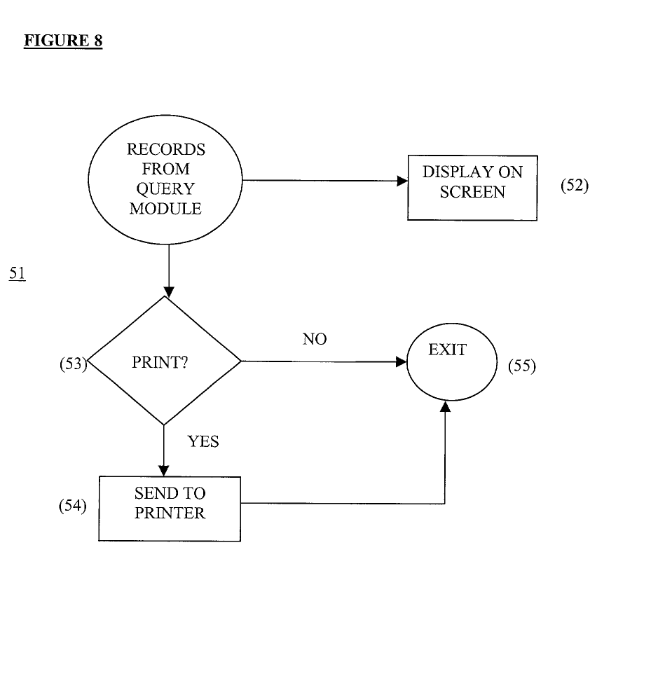

The operational flow chart 51 for the algorithms embodied within the output module 31 of FIG. 3 is depicted in FIG. 8 and operates as follows. The records from the full access query module 22 are displayed on a screen (52) and a decision is made by the attended whether to receive a print out of the records (53). If so the records are sent to the printer (54) for providing a printed record of the events before the attendee exits, if no printed copy is requested, the attendee exits without a printed copy (55).

An arrangement has been described herein whereby a recreational park attendee is provided with identification means that interacts with electronic equipment throughout the park to allow the attendee to purchase food and beverages, locate other members of a group as well as to keep a running account of the expenses occurred while in attendance.

What is claimed is:

1. Apparatus for facilitating amusement park activities comprising:
a plurality of portable transponders arranged for carriage throughout an amusement park facility;
a plurality of stationary readers arranged throughout the amusement park for communication with said portable transponders;
a plurality of kiosks arranged throughout said amusement park, said kiosks including kiosk scanners arranged for interacting with said portable transponders, said kiosks further including kiosk processor units for storing information relating to amusement park functions; and
a main processor unit arranged within said amusement park, said main processor including means for storing both daily and archived attendee-generated demographic information.

2. The apparatus of claim 1 wherein said communications bracelets include a portable transponder carried by a pair of straps adapted to be worn on the persons of a plurality of park attendees.

3. The apparatus of claim 2 wherein said portable transponders further include an attendee scanner adapted for interacting with said kiosk scanners to exchange said demographic information therewith.

4. The apparatus of claim 1 wherein said stationary readers include stationary antennas packaged with transceiver and decoder adapted for interacting with said attendee transponders for exchanging attendee-generated ID information therewith.

5. The apparatus of claim 1 wherein said main processor unit includes a data input module connecting with a databus module for providing attendee input data to said database module.

6. The apparatus of claim 5 wherein said database module interconnects with an output module via a full access query module and a limited access query module for providing data, information.

7. The apparatus of claim 1 wherein said demographic information includes location data for determining location of any of one of said attendees.

8. A method for facilitating amusement park information comprising the steps of:
providing a plurality of portable attendee transponders containing stored ID and demographic data;
positioning a plurality of stationary readers within an amusement park facility, said stationary readers including a plurality of transceivers and decoders adapted for exchanging said ID data with said attendee transponder;
positioning a plurality of stationary kiosks within said amusement park facility, said kiosks including a plurality of kiosk scanners adapted for exchanging said ID and demographic data with said attendee transponders and with said readers; and
arranging a main processor unit within said amusement park, said main processor including means for storing both daily information and archived information.

9. The method of claim 8 wherein said stationary kiosks further exchange food, beverage, credit card and entertainment data with said main processor with regards to the said attendee ID data.

10. The method of claim 8 wherein said main processor provides said ID and demographic data to said amusement park for determining attendee selection of said amusement park functions and said food and beverage.

11. The method of claim 8 wherein said main processor adds said ID to an electronic line for said park attraction for a specific time.
